(19) United States
(12) Patent Application Publication
(10) Pub. No.: US 2008/0243330 A1
(43) Pub. Date: Oct. 2, 2008

(54) Stop-off facility guidance systems, methods, and programs

(75) Inventor: Kazuya Kato, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/073,781

(22) Filed: Mar. 10, 2008

(30) Foreign Application Priority Data
Mar. 30, 2007 (JP) 2007-094036

(51) Int. Cl. G01M 17/00; G06F 19/00

(52) U.S. Cl. 701/30

(57) ABSTRACT

Stop-off facility guidance systems, methods, and programs calculate a time required for vehicle maintenance at a predetermined facility, search for stop-off facilities within a surrounding area of the predetermined facility, and display the searched for stop-off facilities on a display. The systems, methods, and programs receive an input selecting one of the displayed stop-off facilities, calculate a total time required for visiting the selected stop-off facility and returning to the predetermined facility on foot, and compare the calculated total time with a time required for the vehicle maintenance. Based on the comparison, the systems, methods, and programs provide a notification on the display indicating whether the selected stop-off facility can be visited on foot.

### INCORPORATION BY REFERENCE

The disclosure of Japanese Patent Application No. 2007-094036, filed on Mar. 30, 2007, including the specification, drawings and abstract thereof, is incorporated herein by reference in its entirety.

### BACKGROUND

1. Related Technical Fields

Related technical fields include stop-off facility guidance systems, methods, and programs.

2. Related Art

Traditionally, when the driver travels to a facility for vehicle maintenance, the driver must wait in a waiting room that is built in the facility and the like until the vehicle maintenance is finished. Similarly, when the driver goes to a gas station to wash the vehicle, the driver waits in a waiting room that is built in the gas station until the car wash is finished. When the driver goes to a motor vehicle repair shop to undergo the vehicle inspection and maintenance, the driver waits in a waiting room which is built in the motor vehicle repair shop until the vehicle inspection and maintenance is finished.

Further, if vehicle is an electric vehicle such as a hybrid vehicle or an electric-powered vehicle, when the driver goes to a battery charging facility such as an electric station or a parking area in which a battery charger is mounted, the driver waits in a waiting room which is built in the battery charging facility until the battery charge is finished.

However, when it takes a long time to finish the battery charge at the battery charging facility, it is difficult for the driver to wait until the battery charge is finished. Therefore, a vehicle disclosed in Japanese Unexamined Patent Application Publication No. 2006-112932 is provided with display information of stop-off points such as sightseeing facilities in conjunction with information of battery charging facilities, so that a driver can visit the sightseeing facilities and the like near the battery charging facility while the battery charges.

### SUMMARY

According to Japanese Unexamined Patent Application Publication No. 2006-112932, stop-off facilities near a battery charging facility are simply displayed, so that after the driver stops at the sightseeing facilities during the battery charge, the driver cannot know whether he/she could be back to the battery charging facility before the battery charge is terminated.

Various exemplary implementations of the broad principles described herein provide stop-off facility guidance system, methods, and programs that allow a driver, to know whether he/she could visit stop-off facilities near the predetermined facility on foot while vehicle maintenance is undergone at a predetermined facility.

Exemplary implementations provide stop-off facility guidance systems, methods, and programs that calculate a time required for vehicle maintenance at a predetermined facility, search for stop-off facilities within a surrounding area of the predetermined facility, and display the searched for stop-off facilities on a display. The systems, methods, and programs receive an input selecting one of the displayed stop-off facilities, calculate a total time required for visiting the selected stop-off facility and returning to the predetermined facility on foot, and compare the calculated total time with a time required for the vehicle maintenance. Based on the comparison, the systems, methods, and programs provide a notification on the display indicating whether the selected stop-off facility can be visited on foot.

### BRIEF DESCRIPTION OF THE DRAWINGS

Exemplary implementations will now be described with reference to the accompanying drawings, wherein:

FIG. 1 is a diagram showing an exemplary electric vehicle drive control system;

FIGS. 2 and 3 are flowcharts showing an exemplary stop-off guidance method; and

FIG. 4 is an exemplary average stopover time map.

### DETAILED DESCRIPTION OF EXEMPLARY IMPLEMENTATIONS

An example of a stop-off facility guidance system will be described below in which a hybrid vehicle travels to a parking area as a predetermined facility and a battery of the hybrid vehicle is charged as vehicle maintenance.

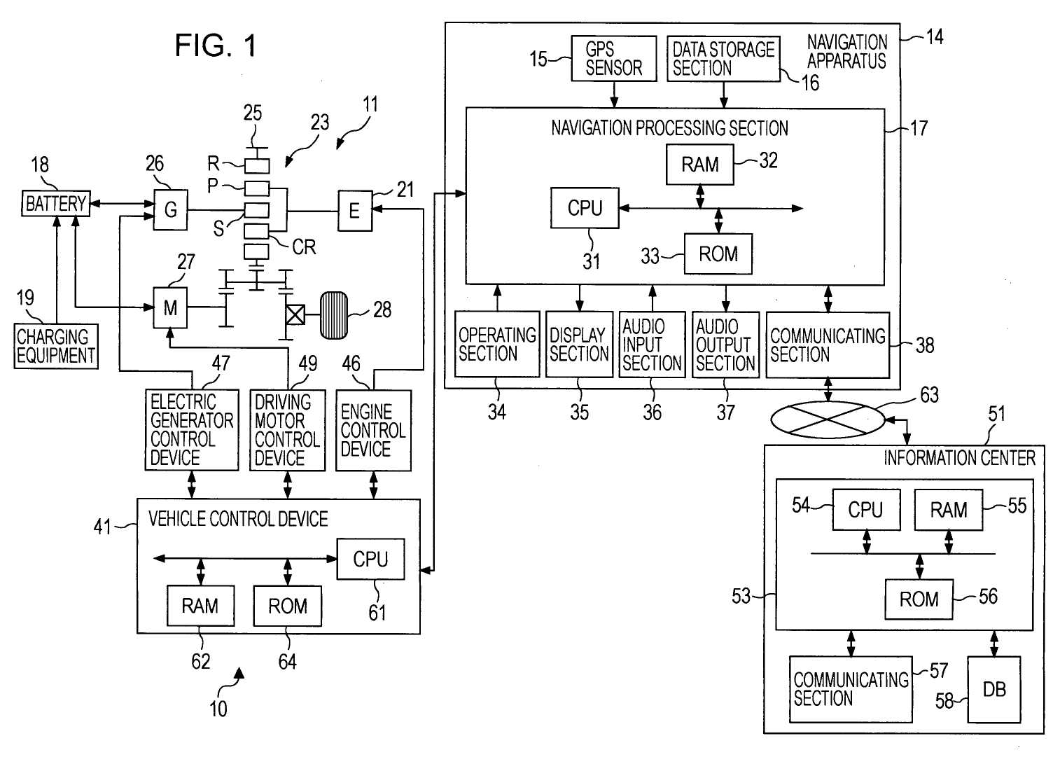

FIG. 1 is a diagram showing an exemplary electric vehicle drive control system according to an example of the current invention. As shown in FIG. 1, the system includes an electric vehicle drive control device 10, an electric drive device 11, an information terminal 14 such as, for example, a navigation apparatus as an in-vehicle device which is mounted in the hybrid vehicle. The system includes a network 63 and an information center 51 as an information provider. A navigation system may include the navigation apparatus 14, the network 63, and the information center 51. Further, an electric vehicle drive control system may include the navigation system, the electric vehicle drive control device 10, the electric drive device 11, and the like. Note that, a stop-off facility guidance system for providing guidance of stop-off facilities may include the electric vehicle drive control system.

The electric drive device 11 may include an engine (E) 21 as a first driving power source, a planetary gear unit 23 for shifting gears by changing the rotation which is transferred from the engine 21 and for allowing torque distribution as a differential rotating device, an output gear 25 for outputting the distributed torque by the planetary gear unit 23, and an electric generator (G) 26 as both a second driving power source which is connected to the planetary gear unit 23 and a first electric machine.

The planetary gear unit 23 may include at least a sun gear S as a first differential element, a pinion P meshing with the sun gear S, a ring gear R meshing with the pinion P as a second differential element, and a carrier CR supporting the pinion P rotatably as a third differential element. The sun gear S is connected to the electric generator 26. The ring gear R is connected to both a driving motor (M) 27, as a third driving power source and a second electric machine, and a driving wheel 28. The carrier CR is connected to the engine 21. The engine 21, the electric generator 26, and the driving motor 27 are connected to each other differential rotatably and mechanically through the planetary gear unit 23 while mechanically connected to the driving wheel 28 as well.

Note that, a one-way clutch (not shown) is mounted between the carrier CR and a case (not shown) of the electric vehicle drive control device 10, so that the inverse rotation is not transferred to the engine 21 because of the one-way clutch.

The electric generator 26 generates electricity using the rotation that is transferred from the planetary gear unit 23. Thereby, the electric generator 26 is connected to a battery 18 as a charging element and provides direct current to the battery 18. In the electric generator 26, an electric generator brake (not shown) is mounted between a rotor (not shown) and the case. The rotor is fixed by engaging with the electric generator brake, so that it is possible to mechanically stop the rotation of the electric generator 26.

Note that, according to the current example, it is possible to charge the battery 18 by supplying midnight power at a facility (point) such as a home and the like in which a predetermined charging equipment 19 is mounted for using commercial electricity. Therefore, an outlet (not shown) is mounted on the charging equipment 19 and a plug (not shown) is mounted on the hybrid vehicle and the battery 18 is connected to the charging equipment 19 by inserting the plug into the outlet. Note that, according to the current example, only the battery 18 is charged. However, for example, a capacitor as a charging element may be charged just as the battery 18.

The electric generator 26 is connected to the battery 18 through an electric generator inverter (not shown). The electric generator inverter converts direct current that is supplied from the battery 18 to phase U, phase V, and phase W, that is, alternating current and transfers alternating current to the electric generator 26. The electric generator 26 is activated in response to this and an electric generator torque, which is a torque of the electric generator 26, is generated.

The driving motor 27 is connected to the battery 18 through a driving motor inverter (not shown). The driving motor inverter converts direct current that is supplied from the battery 18 to phase U, phase V, and phase W, that is, alternating current and transfers alternating current to the driving motor 27. The driving motor 27 is activated in response to this and a driving motor torque, which is a torque of the driving motor 27, is generated. Note that, for example, while the hybrid vehicle is suspended, electricity that is regenerated by the driving motor 27 may be charged in the battery 18.

Next, the electric vehicle drive control device 10 for controlling the electric drive device 11 will be described. The electric vehicle drive control device 10 may include a vehicle control device 41 for controlling the entire hybrid vehicle. The vehicle control device 41 is connected to an engine control device 46 for controlling the engine 21, an electric generator control device 47 for controlling the electric generator 26, and a driving motor control device 49 for controlling the driving motor 27 while being connected to a navigation processing section 17 of the navigation apparatus 14.

The vehicle control device 41 may include a CPU 61, a RAM 62, which is used as a working memory when various types of calculating processing are executed by the CPU 61, and a ROM 64 in which control programs are stored. Each of the engine control device 46, the electric generator control device 47, and the driving motor control device 49 may include the CPU, the RAM, the ROM, and the like (not shown) to control the engine 21, the electric generator 26, or the driving motor 27.

Note that, a first control device which is at a lower level than the vehicle control device 41 may include the engine control device 46, the electric generator control device 47, the driving motor control device 49, and the navigation processing section 17. Similarly, a second control device which is at a higher level than the engine control device 46, the electric generator control device 47, the driving motor control device 49, and the navigation processing section 17 may include the vehicle control device 41.

The navigation apparatus 14 may include a GPS sensor 15 as a current position detecting section for detecting a vehicle position which is a current position of the hybrid vehicle and a vehicle direction which is the direction of the hybrid vehicle, a data storage section 16 as an information storage section for storing various information such as map data (not shown), the navigation processing section 17 for executing various calculation processing such as a navigation processing, and an operating section 34 as a first input section for operating a predetermined input by a driver's (a user's) operation. The navigation apparatus 14 may include a display section 35 as a first output section for proving various types of display using images which are displayed on a screen (not shown) and notifying the driver of the displays, an audio input section 36 as a second input section for operating a predetermined input by the driver's voice, an audio output section 37 as a second output section for operating audio output and notifying the driver of various information, and a communicating section 38 as a transferring/receiving section which is functioned as a communication terminal. The navigation processing section 17 is connected to the GPS sensor 15, the data storage section 16, the operating section 34, the display section 35, the audio input section 36, the audio output section 37, and the communicating section 38. The GPS sensor 15 detects a time in addition to the vehicle position and the vehicle direction. Note that, the vehicle direction may be detected by a direction sensor, which is mounted in addition to the GPS sensor 15.

The data storage section 16 may include a map database (not shown) including map data files containing map data. As map data, intersection data according to intersections (branch points), node data according to nodes, road data according to road links, search data that is modified for a search, facility data according to facilities, and feature data according to features on roads may be included.

The data storage section 16 may further include a statistical database (not shown) including statistical data files and a travel history database (not shown) including travel history data files. Statistical data is stored as past record data in the statistical data files and similarly travel history data is stored as past record data in the travel history data files.

The data storage section 16 may include a disk (not shown) such as a hard disk, a CD, a DVD, or an optical disk for storing various data described above and further include a head (not shown) such as a reading/writing head for reading/writing various data. For example, a memory card may be used as the data storage section 16. Note that, an external storage device may be structured by each of the disks described above and/or the memory card.

According to the current example, the map database, the statistical database, the travel history database, and the like are included in the data storage section 16. However, the map database, the statistical database, the travel history database, and the like may be included in the information center 51.

The navigation processing section 17 may include a CPU 31 as a control device for controlling the entire navigation apparatus 14 and as a calculating device, a RAM 32 which is used as a working memory when the CPU 31 executes various calculating processing, a ROM 33 in which control programs and various programs for operating a route search for a destination, a route guidance, and the like are stored, and a flash memory (not shown) which is used for storing various data and programs.

As the operating section 34, a keyboard or a mouse (not shown), which is mounted in addition to the display section 35, may be used. Further, a touch panel may be used as the operating section 34 for executing predetermined input operations. Specifically, an image operating section such as various types of keys, switches, and/or buttons displayed as an image on a screen of the display section 35, that is, the touch panel, is touched or clicked and the predetermined input operations are executed.

A display may be used as the display section 35. The vehicle position, the vehicle direction, a map, a route to be searched for, guidance information and traffic information along the searched route, a distance to next intersection along the searched route, and a travel direction at next intersection may be displayed.

The audio input section 36 may include a microphone (not shown) to input necessary information by voice. The audio output section 37 may include an audio synthesis device and a speaker (not shown) to provide route guidance according to the searched route with audio output.

The communicating section 38 may include a beacon receiver (not shown) for receiving various information such as general information and/or current traffic information which are transferred from a road traffic information center such as a VICS (Vehicle Information and Communication System®) center and an FM receiver (not shown) for receiving FM multiple broadcasting through an FM broadcasting station. In addition to various information such as general information and traffic information, the communicating section 38 may receive data such as map data, statistical data, travel history data, and the like from the information center 51 through the network 63.

To transfer such data, the information center 51 may include a server 53, a communicating section 57, and a database (DB) 58 as an information storage section. The server 53 may further include a CPU 54, a RAM 55, and a ROM 56. In the database 58, same data as various data that is stored in the data storage section 16 is stored.

Note that, the electric vehicle drive control system, the electric vehicle drive control device 10, the engine control device 46, the electric generator control device 47, the driving motor control device 49, the navigation system, the navigation processing section 17, the server 53, the CPUs 31, 54, and 61 may be implemented by a single controller (CPU) or a plurality of CPUs for executing calculating processing based on various programs and data.

A storage device and a storage medium may be structured with the data storage section 16, the RAMs 32, 55, 62, the ROMs 33, 56, 64, and a flash memory. A calculating device may be structured with the CPU 31, 54, and 61. As the calculating device, for example, a MPU may be used instead of the CPU 31, 54, or 61.

Next, basic operations of the navigation apparatus 14 will be described. First, when a driver operates the operating section 34 and the navigation apparatus 14 is activated, the CPU 31 executes a current position reading processing, so that a vehicle position and a vehicle direction, which are detected by the GPS sensor 15, are read. Next, the CPU 31 executes a vehicle position calculating processing (matching processing), so that the vehicle position is calculated and specified by determining which road link the vehicle position is located on based on the locus of the read vehicle positions and shapes and orders of road links which are formed roads surrounding the vehicle position.

The CPU 31 executes a basic information obtaining processing for reading out and obtaining the map data from the data storage section 16 or for receiving and obtaining the map data from, for example, the information center 51 through the communicating section 38. Note that, when the map data is obtained from, for example, the information center 51, the CPU 31 downloads the received map data onto the flash memory.

The CPU 31 executes a display processing for creating various types of screens on the display section 35. For example, the CPU 31 executes a map display processing, so that a map screen is generated on the display section 35 and a map of a surrounding area, the Vehicle position, and the vehicle direction are displayed on the map screen.

Therefore, the driver can drive the vehicle based on the displayed map data, the vehicle position, and the vehicle direction.

When the driver inputs a destination by operating the operating section 34, the CPU 31 executes a destination setting processing for setting the destination. Note that, according to the current example, instead of operating the operating section 34 to input the destination, the driver can input an activity schedule indicating a travel plan of the hybrid vehicle using a terminal device (not shown) such as an electric personal organizer, a PC, and the like. Therefore, the navigation apparatus 14 may include the communicating section 38 for transferring/receiving data with a connector or a PC (not shown), which is for connecting the electric personal organizer and the like.

In the activity schedule, for example, starting points, destinations, scheduled starting times at the starting points, and scheduled arrival times at the destinations are stored by date.

Next, in the navigation apparatus 14, the CPU 31 executes an activity schedule obtaining processing, so that the activity schedule which was input from the terminal device is read and obtained before the hybrid vehicle starts traveling, and the activity schedule, connecting a starting at a home as a first starting point to an arrival to the home as a last destination through each of destinations, is set as a destination schedule.

The destination schedule is set as described above. If needed, the driver inputs search conditions by operating the operating section 34 and the CPU 31 executes a search processing, so that the vehicle position, the destination schedule, and the like are read, search data and charging facility data of a parking area, an electric station, and the like, which includes a charging equipment (hereinafter referred to as “charging facility data”) are read out among facility data, a route from the first starting point to the last destination on the destination schedule is searched for according to the search conditions based on the vehicle position, the destination, search data, charging facility data, and the like, and finally the route data is output.

Note that, the searched route is a collection of routes that are from each starting point to each destination on the destination schedule. Route data may include, not only data indicating searched routes, but data indicating charging facilities that are searched for on the searched routes. According to the search processing, the route which has the minimum total link cost, a link cost is assigned to each road link, is searched for.

According to the current example, the CPU 31 executes the search processing. However, the information center 51 may execute the search processing instead.

The CPU 31 executes a guidance processing and the route guidance. The CPU 31 executes a route display processing, so that the route data is read in and the searched route is displayed on the map screen based on the read route data.

Meanwhile, the electric generator 26 and the driving motor 27 are activated by electric current that is supplied from the battery 18. In this case, it is preferable to run down the electricity that was charged in the battery 18 before the next charge in terms of a pollution issue and/or an energy-saving problem. However, if the electricity is run down while the hybrid vehicle is traveling, the hybrid vehicle has to travel using only the engine 21 in spite of a HV travel mode and this is not preferable in terms of the pollution issue and/or the energy-saving problem. Further, a vehicle request torque that is necessary for driving the hybrid vehicle cannot be generated enough.

To solve the problems described above, according to the current example, the navigation apparatus 14 sets charging facilities as planned charging points based on the search data and each of ideal battery remaining amounts (SOC) at charging points along the routes between each starting point (at which the battery can be charged) and each planned charging point is set as a target value of the battery remaining amount SOC, that is, a target battery remaining amount SOC* as a target charging capacity. The navigation apparatus 14 calculates the target battery remaining amount SOC* as the target charging capacity.

The CPU 31 executes an energy control determination processing as a charging schedule setting processing. As charging conditions, the battery remaining amount SOC as the charging capacity at the first starting point, the distance from the starting point at which the hybrid vehicle can be charged to the planned charging point, a time spent on charging at each planned charging point between the arrival at the point and the departure from the point (that is, a time period which can be spent at the charging point), a time necessary for full-charging the battery 18 (that is, a time required for charging), and the like are read in and the travel distance from the starting point at which the vehicle can be charged is calculated based on the charging conditions. Next, the target battery remaining amounts SOC* at each of points are calculated in such a way that the battery remaining amount SOC becomes 0% at the arrival to the next planned charging point. In this way, the charging schedule including the target battery remaining amounts SOC* at each of points is set.

Note that, a facility at which maintenance will be undergone (that is, a planned maintenance point) is set from the planned charging points. A maintenance and charging time at each of the planned maintenance points is set based on the time which can be spent at the charging point. A time required for the maintenance is set based on the time required for charging.

The battery remaining amount SOC denotes a value indicating the percentage of the charge amount which is actually charged in the battery 18 against the capacity of the battery 18, that is, the amount of charge remaining in the battery. When the battery 18 is full-charged and the percentage of the charge vs. the capacity of the battery 18 is 100%, the battery remaining amount SOC is 100%.

To calculate the battery remaining amount SOC, a battery voltage sensor and a battery current sensor may be mounted in the battery 18. The sensor output from the battery voltage sensor and the sensor output from the battery current sensor are supplied to the vehicle control device 41. In response to this, the vehicle control device 41 executes a battery remaining amount calculating processing as an amount of charge calculating processing for calculating the battery remaining amount SOC.

In this case, the first starting point and the last destination are both the home. The battery 18 is full-charged at the departure at the home, so that the battery remaining amount SOC at that time is 100%, and the battery remaining amount SOC becomes 0% at the arrival at the home. Each of the battery remaining amounts SOC at each of the planned charging points is nearly 0% so as to charge the battery of the vehicle at the planned charging points. Note that, when the time which can be spent at the planned charging point is shorter than the time required for charging, the charging is started as soon as the vehicle arrives at the planned charging point and the charging is terminated when the vehicle leaves from the point. In this case, although the battery remaining amount SOC does not reach 100%, the vehicle goes to the next destination.

Note that, as the battery remaining amount SOC here, 100% and 0% do not indicate the physical remaining amount. 100% and 0% of SOC indicate the highest remaining amount and the lowest remaining amount based on the economical repeated use of the battery 18. Further, the battery remaining amount SOC is different depending on the cause of the performance, the material, and the like of the battery 18. For example, when the battery 18 is an alkaline battery, the battery may be used until the SOC becomes very low. Meanwhile, when the battery 18 is a zinc battery, using the zinc battery until the SOC becomes excessively low causes the battery life to be shortened, so that a state which a predetermined amount of charge is still remaining in the zinc battery is set as 0% of the battery remaining amount SOC for the zinc battery.

As described above, when the charging schedule is set, the CPU 31 executes a drive control instruction processing, so that the charging schedule which is the determination result by the energy control determination processing is notified to the electric vehicle drive control device 10 and the activation of the electric drive device 11 is instructed.

The CPU 61 executes a drive control processing and activates the electric drive device 11 based on the charging schedule. Operations of the CPU 61 will be described.

First, the CPU 61 executes a driving condition obtaining processing, so that a position of an accelerator pedal is read from an accelerator switch which is mounted on the accelerator pedal (not shown) and a position of a brake pedal is read from a brake switch which is mounted on the brake pedal (not shown). Further, a position of a rotor is read from a rotor position sensor (for example, a resolver) (not shown) as a position detecting section, which is mounted on the driving motor 27, and the vehicle speed is calculated as a travel condition based on the rotor position. In this case, the accelerator switch and the brake switch are functioning as driving operation amount detecting sections and the rotor position sensor is functioning as a vehicle speed detecting section. Note that, the vehicle speed may be detected by a vehicle speed sensor that is mounted on the output gear 25 as the vehicle speed detecting section.

The CPU 61 executes a vehicle request torque calculating processing, so that a vehicle request torque TO* which is necessary for driving the hybrid vehicle is calculated based on the accelerator pedal position, the brake pedal position, and the vehicle speed.

Next, the CPU 61 executes a vehicle request torque determination processing, to determine whether the vehicle request torque TO* is greater than a driving motor maximum torque which is a preset maximum driving motor torque as a rating torque of the diving motor 27. When the vehicle request torque TO* is greater than the driving motor maximum torque, the CPU 61 executes an abrupt acceleration control processing, to determine whether the engine 21 is suspended. When the engine 21 is suspended, the electric generator 26 and the driving motor 27 are activated to make the hybrid vehicle travel in the EV travel mode.

When the vehicle request torque TO* is equal to or less than the driving motor maximum torque or when the vehicle request torque TO* is greater than the driving motor maximum torque while the engine 21 is not suspended, the CPU 61 executes a driver request output calculating processing. A driver request output PD is calculated by multiplying the vehicle request torque TO* by the vehicle speed. The CPU 61 executes a battery charge-discharge request output calculating processing. The charging schedule is read from the navigation apparatus 14 while the battery remaining amount SOC is read. Then, a battery charge-discharge request output LSOC is calculated as a charge-discharge request output in such a way that the current battery remaining amount SOC is brought close to the target battery remaining amount SOC* of the charging schedule. The CPU 61 executes a vehicle request output calculating processing, so that a vehicle request output PO is calculated by adding the driver request output PD to the battery charge-discharge request output LSOC.

Next, the CPU 61 executes an engine target driving condition setting processing. An engine target driving condition map which is stored in the ROM 64 is referred to determine a driving point which is a point at which the efficiency of the engine 21 becomes the highest on a most suitable fuel efficiency curve based on the vehicle request output PO, the accelerator pedal position, and the like. The torque of the engine 21 at the determined driving point, that is, an engine torque TE, is determined as an engine target torque TE* indicating the target value of the engine torque TE. Further, an engine rotation speed at the determined driving point, that is, an engine rotation speed NE, is determined as an engine target rotation speed NE* indicating the target value of the engine rotation speed NE and the engine target rotation speed NE* is transferred to the engine control device 46.

The engine control device 46 refers to an engine drivable range map which is stored in the ROM as a storage device of the engine control device 46 and determines whether the electric drive device 11 is located within a drivable range which is for activating the engine 21 based on the vehicle speed, the battery remaining amount SOC, and the vehicle request torque TO*. In this case, the greater the battery remaining amount SOC is, the narrower the drivable range becomes. Similarly, the smaller the battery remaining amount SOC is, the larger the drivable range becomes.

When the engine 21 is not activated even though the engine 21 is located within the drivable range, the engine control device 46 executes an engine control processing. In this processing, the engine 21 starts to be activated to make the hybrid vehicle travel in the HV travel mode. When the engine 21 is activated even though the engine 21 is not located within the drivable range, the driving of the engine 21 is terminated and the hybrid vehicle is made to travel in the EV travel mode.

When the engine 21 is not located within the drivable range and not activated, the CPU 61 executes a driving motor target torque calculating processing. The vehicle request torque TO* is calculated as a driving motor target torque TM* indicating the target value of the driving motor torque TM and the calculated driving motor target torque TM* is transferred to the driving motor control device 49. In this case, the driving motor control device 49 executes a driving motor control processing for controlling the torque of the driving motor 27.

When the engine 21 is located within the drivable range and activated, the engine 21 is controlled using a predetermined method.

Next, the electric generator control device 47 executes an electric generator target rotation speed calculating processing. Specifically, the electric generator control device 47 reads the rotor position from the rotor position sensor and calculates the rotation speed of the ring gear R based on the rotor position. At the same time, the engine target rotation speed NE* is read and the rotation speed of the electric generator 26, that is, an electric generator target rotation speed NG* indicating the target value of the electric generator rotation speed NG is calculated based on the rotation speed of the ring gear R and the engine target rotation speed NE* because the rotation speed of the electric generator 26 responds to the engine target rotation speed NE* by a rotation speed's relational expression which is represented by a gear teeth ratio of the sun gear S, the pinion P, and the ring gear R of the planetary gear unit 23.

By the way, when the hybrid vehicle which has the structure described above is driven by using the engine 21 and the driving motor 27 in the HV travel mode, if the electric generator rotation speed NG is low, it requires a measurable amount of power and the power generation efficiency of the electric generator 26 becomes down, so that the fuel efficiency of the hybrid vehicle becomes lower. Therefore, when the electric generator rotation speed NG is low, the brake of the electric generator is engaged and the electric generator 26 is stopped mechanically. As the result, the fuel efficiency becomes better.

When the electric generator target torque TG* indicating the target value of the electric generator torque TG is determined, the electric generator control device 47 controls the torque of the electric generator 26 based on the electric generator target torque TG*. A predetermined electric generator torque TG is generated and an engine torque TE, the torque of the ring gear R, that is, the ring gear torque, and the electric generator torque TG receive reaction forces from each other, so that the electric generator torque TG is converted to the ring gear torque and output from the ring gear R. In this case, the ring gear torque is output from the ring gear R and the electric generator rotation speed NG is changed and further the ring gear torque is changed as well. The changed ring gear torque is transferred to the driving wheel 28, so that the sensation of driving of the hybrid vehicle becomes worse.

The CPU 61 calculates the ring gear torque in prospect of the torque for inertia of the electric generator 26 depending on the change of the electric generator rotation speed NG and estimates a torque of an output shaft of the driving motor 27, that is, a driving shaft torque based on the ring gear torque. By subtracting the driving shaft torque from the vehicle request torque TO*, the over-short value of the driving shaft torque is calculated as the driving motor target torque TM*.

In the current example described above, according to the driving conditions such as the charging schedule, the acceleration pedal position, the brake pedal position, the vehicle speed, the battery remaining amount SOC, and the like, the hybrid vehicle travels in the EV travel mode by terminating the engine 21 and activating both the electric generator 26 and the driving motor 27 or by terminating both the engine 21 and the electric generator 26 and activating only the driving motor 27. Meanwhile, the hybrid vehicle travels in the HV travel mode by activating both the engine 21 and the driving motor 27 and activating the electric generator 26 to receive the reactive force, or by activating both the engine 21 and the driving motor 27 and mechanically terminating the electric generator 26.

When a predetermined charging facility, for example, a parking area is set as the planned charging point, guidance of facilities near the parking area is provided as well, so that the driver can visit the facilities while the vehicle is charged at the parking area.

The CPU 31 executes a stop-off guidance processing, so that stop-off facilities are searched for and guidance of the searched facilities is provided to the driver.

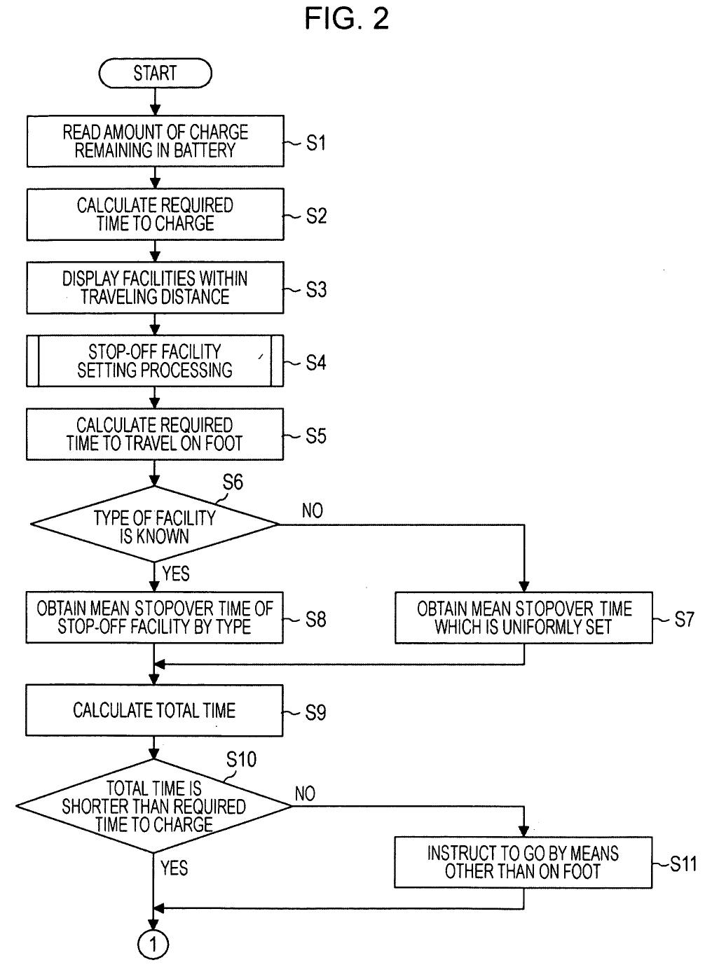

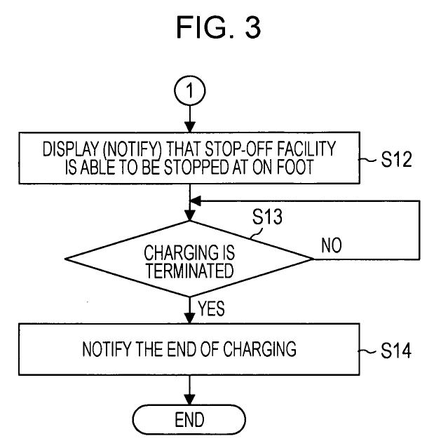

FIGS. 2 and 3 are flowcharts showing an exemplary stop-off guidance method according to the example of the current invention. The exemplary method may be implemented, for example, by one or more components of the above-described system. However, even though the exemplary structure of the above-described system may be referenced in the description, it should be appreciated that the structure is exemplary and the exemplary method need not be limited by any of the above-described exemplary structure. For example, the method may be implemented by the CPU 31 executing a program stored in the ROM 33.

In the method, the CPU 31 reads the battery remaining amount SOC (S1) when the vehicle arrives at the parking area and the time required for charging by the charging equipment at the parking area is calculated (S2) based on the battery remaining amount SOC. In response to this, the time required for charging is displayed on the display section 35 (S3).

The CPU 31 then executes a stop-off facility search processing. In this processing, facility data is read out and facilities within a range that the driver can travel on foot from the parking area (according to the current example, within a 1000-meter radius), are searched for as stop-off facilities. The CPU 31 displays such stop-off facilities in a list form on the display section 35 and further displays marks indicating the stop-off facilities on the map, which is displayed on the display section 35.

When the driver operates the operating section 34 to select one stop-off facility from a displayed list or from the map on which the marks indicating the stop-off facilities are displayed, the CPU 31 executes a stop-off facility setting processing (S4) to set the selected stop-off facility. The CPU 31 sets the parking area as the starting point, searches for a route to the selected stop-off facility as the destination, and sets the searched route as a stop-off route.

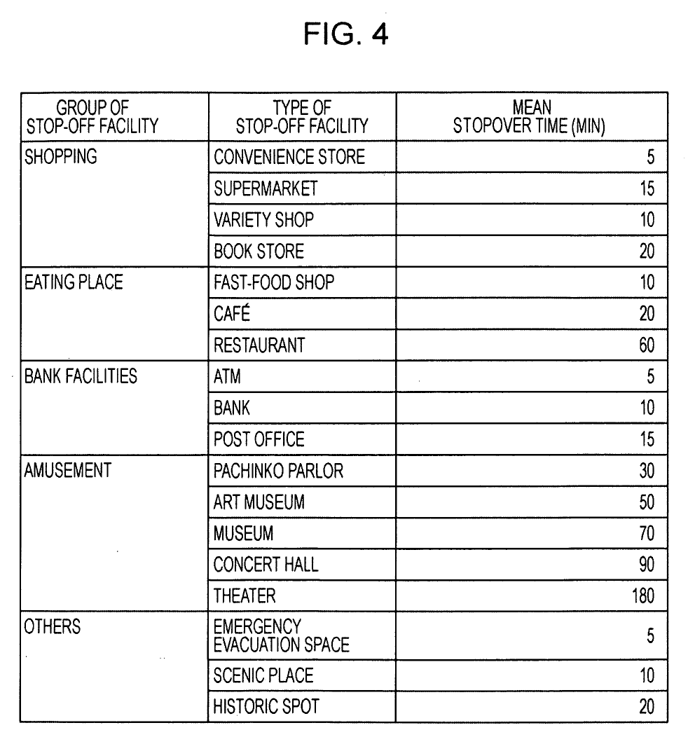

Next, the CPU 31 executes a total time calculating processing. Specifically, a necessary time the driver takes to travel from the parking area to the stop-off facility on foot, that is, a walking time as a travel time is calculated based on the stop-off route (S5). The CPU 31 determines whether the type of the stop-off facility is known (S6). When the type of the stop-off facility is known (S6=YES), the CPU 31 refers to the average (mean) stopover time map which is set in the ROM 33 (e.g., as shown in FIG. 4) and reads out and obtains the mean stopover time of the stop-off facility by type (S8). Meanwhile, when the type of the stop-off facility is not known (S6=NO), the CPU 31 reads out and obtains a standard mean stopover time (hereinafter referred to as “standard stopover time”) which is uniformly set and stored in, for example, a buffer (not shown) of the CPU 31 (S7). According to the current example, the standard stopover time is stored in the buffer. However, the standard stopover time may be stored in a predetermined range of the mean stopover time map separate from the mean stopover times by type. Note that, in the mean stopover time map, the stop-off facilities are sorted by group and further by type and the mean stopover times corresponding to each of the types of the stop-off facilities are sorted and stored.

The CPU 31 calculates a round-trip time between the parking area and the selected stop-off facility by doubling the walking time. Further, the total time, which is a total time necessary for leaving the parking area, stopping at the selected stop-off facility, staying at the selected stop-off facility for the corresponding mean stopover time, and getting back to the parking area from the selected stop-off facility, is calculated by adding the calculated round-trip time to the mean stopover time (S9).

The CPU 31 executes a comparison processing to compare the total time with the time required for charging. After it is determined whether the total time is shorter than the time required for charging (S10), the CPU 31 displays a message whether the selected stop-off facility can be visited on foot on the display section 35.

Specifically, when the total time is shorter than the time required for charging (S10=YES), the CPU 31 displays a message indicating that the selected stop-off facility can be visited on foot (S12). In this case, the CPU 31 displays, for example, the walking time, the mean stopover time, and the available time for staying at the stop-off facility on the map. When the total time is longer than the time required for charging (S10=NO), the CPU 31 displays a message indicating that the selected stop-off facility should be visited by any method other than on foot, for example, by vehicle after the charging (S11). When the total time is longer than the time required for charging, the CPU 31 may display the message indicating that the selected stop-off facility cannot be visited on foot.

Note that, according to the current example, the CPU 31 determines whether the total time is shorter than the time required for charging. When the total time is shorter than the time required for charging, the CPU 31 displays the message indicating that the stop-off facility can be visited on foot. However, in case of that the driver sets an allowable time in advance, the CPU 31 may display the message indicating that the stop-off facility can be visited on foot even though the actual total time is the allowable time longer than the time required for charging.

The CPU 31 determines whether the charging is terminated (S13). When the charging is terminated (S13=YES), the CPU 31 notifies the driver that the charging is terminated (S14) by, for example, sending a mail to a mobile phone or other communicating device or communicating terminal.

As described above, according to the current example, when the total time is shorter than the time required for charging, the message indicating that the stop-off facility can be visited is displayed. Therefore, when the driver visits the stop-off facility, the driver can easily predict when he/she should get back to the parking area from the stop-off facility.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, the CPU 31 displays the stop-off facilities whose total times are shorter than the time required for charging on the map. However, when the driver registers the type of the stop-off facilities in advance, the CPU 31 may select the stop-off facilities which are in the registered type among the stop-off facilities whose total times are shorter than the time required for charging and displays only the selected stop-off facilities.

Additionally, the information center 51 may distribute event information of facilities that are located within a surrounding area of the parking area (for example, information according to discount sale, concert, lunchtime of eating place) and the distributed event information may be displayed on the display section 35.

What is claimed is:

1. A stop-off facility guidance system for a vehicle, comprising:
a controller that:
calculates a time required for vehicle maintenance at a predetermined facility;
searches for stop-off facilities within a surrounding area of the predetermined facility;
displays the searched for stop-off facilities on a display;
receives an input selecting one of the displayed stop-off facilities;
calculates a total time required for visiting the selected stop-off facility and returning to the predetermined facility on foot;
compares the calculated total time with a time required for the vehicle maintenance; and
based on the comparison, provides a notification on the display indicating whether the selected stop-off facility can be visited on foot.

2. The stop-off facility guidance system of claim 1, further comprising the display.

3. The stop-off facility guidance system of claim 1, wherein the controller calculates the total time based on:
a time required to travel between the predetermined facility and the selected stop-off facility on foot; and
a mean stopover time for the selected stop-off facility.

4. The stop-off facility guidance system of claim 3, further comprising:
a memory that stores mean stopover times for a plurality of stop-off facilities;
wherein the controller reads the mean stopover time for the selected stop-off facility from the memory.

5. The stop-off facility guidance system of claim 3, further comprising:
a memory that stores mean stopover times for a plurality of types of stop-off facilities;
wherein the controller reads a mean stopover time for a type of facility corresponding to the selected stop-off facility from the memory.

6. The stop-off facility guidance system of claim 1, wherein the controller provides a notification that the selected stop-off facility can be visited on foot when the calculated total time is shorter than the time required for the vehicle maintenance.

7. The stop-off facility guidance system of claim 1, wherein the controller:
provides a notification that the vehicle maintenance is terminated when the vehicle maintenance is terminated.

8. The stop-off facility guidance system of claim 7, further comprising:
a communication section;
wherein the notification that the vehicle maintenance is terminated is sent via the communication section to a portable communication device.

9. The stop-off facility guidance system of claim 1, wherein:
the vehicle comprises an electric driving motor; and
the vehicle maintenance is a charging of a charging element that supplies electric power to a battery, the battery supplying electric power to the driving motor.

10. A navigation apparatus comprising the stop-off facility guidance system of claim 1.

11. A stop-off facility guidance method for a vehicle, comprising:
calculating a time required for vehicle maintenance at a predetermined facility;
searching for stop-off facilities within a surrounding area of the predetermined facility;
displaying the searched for stop-off facilities on a display;
receiving an input selecting one of the displayed stop-off facilities;
calculating a total time required for visiting the selected stop-off facility and returning to the predetermined facility on foot;
comparing the calculated total time with a time required for the vehicle maintenance; and
based on the comparison, providing a notification on the display indicating whether the selected stop-off facility can be visited on foot.

12. The stop-off facility guidance method of claim 11, further comprising calculating the total time based on:
a time required to travel between the predetermined facility and the selected stop-off facility on foot; and
a mean stopover time for the selected stop-off facility.

13. The stop-off facility guidance method of claim 12, further comprising:
storing mean stopover times for a plurality of stop-off facilities; and
reading the mean stopover time for the selected stop-off facility from the memory.

14. The stop-off facility guidance method of claim 12, further comprising:
storing mean stopover times for a plurality of types of stop-off facilities; and
reading a mean stopover time for a type of facility corresponding to the selected stop-off facility from the memory.

15. The stop-off facility guidance method of claim 11, further comprising:
providing a notification that the selected stop-off facility can be visited on foot when the calculated total time is shorter than the time required for the vehicle maintenance.

16. The stop-off facility guidance method of claim 11, further comprising:
providing a notification that the vehicle maintenance is terminated when the vehicle maintenance is terminated.

17. The stop-off facility guidance method of claim 16, further comprising:
sending the notification that the vehicle maintenance is terminated to a portable communication device.

18. The stop-off facility guidance method of claim 11, wherein:
the vehicle comprises an electric driving motor; and
the vehicle maintenance is a charging of a charging element that supplies electric power to a battery, the battery supplying electric power to the driving motor.

19. A computer-readable storage medium storing a computer-executable program usable to provide stop-off facility guidance, the program comprising:
instructions for calculating a time required for vehicle maintenance at a predetermined facility;
instructions for searching for stop-off facilities within a surrounding area of the predetermined facility;
instructions for displaying the searched for stop-off facilities on a display;
instructions for receiving an input selecting one of the displayed stop-off facilities;
instructions for calculating a total time required for visiting the selected stop-off facility and returning to the predetermined facility on foot;
instructions for comparing the calculated total time with a time required for the vehicle maintenance; and
instructions for based on the comparison, providing a notification on the display indicating whether the selected stop-off facility can be visited on foot.
